(19) United States
(12) Patent Application Publication
(10) Pub. No.: US 2009/0224071 A1
(43) Pub. Date: Sep. 10, 2009

(54) Soap Dispensing Shower Head

(76) Inventor: Bovendra N. Yogashwer, Elizabethtown, PA (US)

Correspondence Address: SUNG I. OH, PROFESSIONAL LAW CORPORATION, 710 QUAIL VALLEY LANE, WEST COVINA, CA, 91791, US

(21) Appl. No.: 12/044,039

(22) Filed: Mar. 7, 2008

(51) Int. Cl. B05B 7/26; B05B 7/24

(52) U.S. Cl. 239/310; 222/630

(57) ABSTRACT

A showerhead includes a built-in soap dispenser that allows water and liquid soap to mix inside and emerge simultaneously to provide lather from the showerhead. The soap is contained in a cartridge which is clipped to the showerhead.

### TECHNICAL FIELD OF THE INVENTION

The present invention relates to the general art of showers, and to the particular field of showerheads.

### BACKGROUND OF THE INVENTION

The shower bath has an ancient history, with paintings on ancient Greek vases showing that there were shower baths employing advanced systems of water supply and drainage by the fifth century, B.C. In Roman times, the bather was anointed with oil before his bath to reduce the tendency of the skin to dry out after bathing. The shower bath has survived into modern times and has become so common in usage that bathrooms in domestic households generally include a shower nozzle mounted from the wall above the bathtub. The common method of a person taking a shower is to have plain water flow through the shower head onto the person's body, with the person applying the soap by hand or brush to the person's body.

Conventional bathing techniques in the usual shower stall are accompanied with certain difficulties and inconveniences which it is a primary purpose of the present invention to overcome. For example, a not unusual occurrence is for the bather to have difficulty locating and retaining bar soap, which can fall from a receptacle onto the floor of the shower stall, not only making it difficult to find, but also hazardous to the bather. Another frequent occurrence is that the bar soap may be allowed to reside in a receptacle also containing water which wastes the soap.

As a convenience to bathers there is need for a device to soap the water issuing from a shower head so that the bather will not have to handle a wet and slippery bar of soap. By applying the soap directly to the shower spray, the bather may soap his whole body very quickly and efficiently and then, by merely turning a valve, shut off the soapy water and turn on clear water to wash the soap off his body. With such a device, the soap is handled in dry condition and only when it becomes necessary to insert a new bar of soap into the soap chamber of the device.

However, the inventor is not aware of any device which fulfills these needs in an efficient and economical manner. In particular, the replacement of soap after a supply has been exhausted is often a difficult and onerous task.

### SUMMARY OF THE INVENTION

The above-discussed disadvantages of the prior art are overcome by a showerhead which includes a built-in soap dispenser that allows water and liquid soap to mix inside and emerge simultaneously to provide lather from the showerhead. The soap is contained in a cartridge which is clipped to the showerhead.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a soap-dispensing showerhead embodying the present invention.

FIG. 2 shows a soap cartridge for use in the showerhead of FIG. 1.

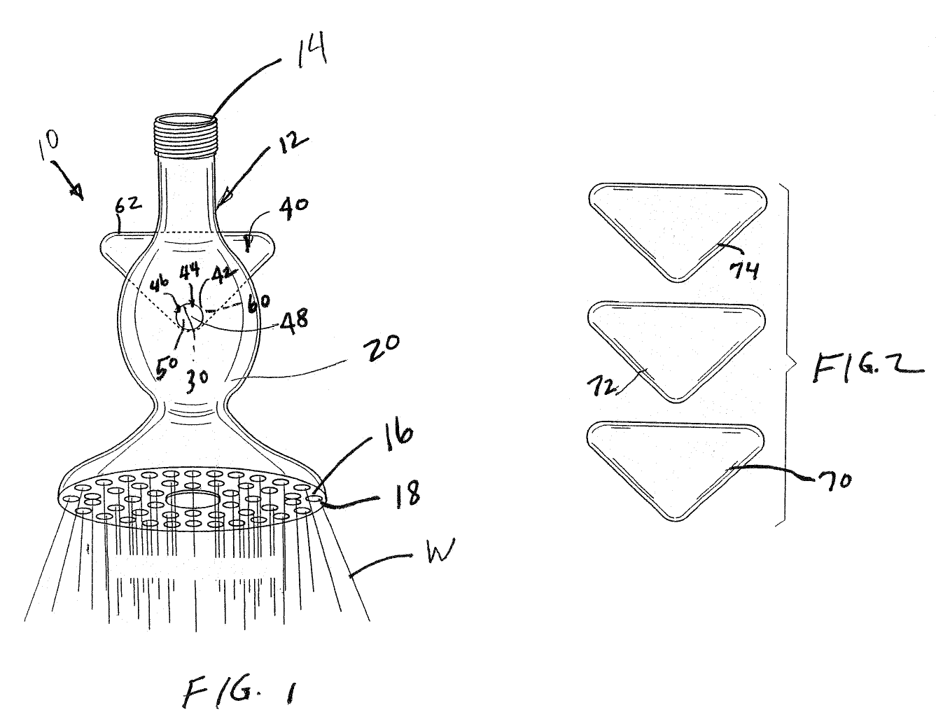

### DETAILED DESCRIPTION OF THE INVENTION

Referring to the figures, it can be understood that the present invention is embodied in a showerhead unit 10 which comprises a showerhead 12. Showerhead 12 includes a first end 14 that is a water inlet end and which is fluidically connected to a source of water and a second end 16 which is a showerface and which has a multiplicity of water outlet ports, such as water outlet port 18, defined therethrough through which water W from the inlet end passes during use of the showerhead. A body 20 fluidically connects first end 14 of the showerhead to second end 16 of the showerhead.

A fluid port 30 is defined through the body of the showerhead. Fluid port 30 is in operational fluid communication with water passing through the body of the showerhead so that water flowing through the body of the showerhead flows into and out of the fluid port.

A soap container unit 40 is mounted on body 18 of the showerhead and includes a fluid flow port 42 which is fluidically connected to fluid port 30 to be in fluid communication with water flowing through the body of the shower head so that water flowing through the body of the showerhead flows into and out of fluid flow port 42 via fluid port 30. Fluid flow port 42 of the soap container unit includes an inlet section 44 and an outlet section 46. A one-way valve 48 is included on inlet section 44 and a one-way valve 50 is included on outlet section 46 so fluid flows into the soap container via fluid flow port 30 and via fluid port 42 from body 18 of the showerhead via inlet section 44 and out of fluid port 30 via fluid flow port 42 back into body 18 of the showerhead via outlet section 46.

Alternatively, the liquid soap in the soap container unit 40 may be drawn into the body 20 of the showerhead unit 10 through the air flow port 42. As water passes through the body 20, lower pressure may be created within the body relative to the atmosphere. As such, the liquid in the soap container unit 40 may be drawn into the body 20 through the air port 42. The soap container unit 40 may have an air inlet opening 62 so that vacuum does not get created within the soap container unit 40 or to substantially maintain an atmospheric pressure within the soap container.

A connection element 60 on the soap container connects the soap container to the body of the showerhead with fluid flow port 42 of the container unit in fluid communication with fluid port 30 of the showerhead. The soap container unit 40 may include soap in a liquid form which can be refilled when necessary. The soap container unit 40 may have a triangular configuration where the connection element 60 is located in one of the three corners of the triangular shaped soap container 40. In the mounted position, the connection element 60 may be on the bottom side of the soap container unit 40 to allow the liquid soap to drain through the connection element 60. Alternatively, the showerhead unit 10 may be provided with replaceable soap container units 70, 72, and 74 to replace the soap container unit 40 when it is empty.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A showerhead system comprising:
A) a showerhead which includes
(1) a first end that is a water inlet end and which is fluidically connected to a source of water,
(2) a second end which is a showerface and which has a multiplicity of water outlet ports defined therethrough through which water from the inlet end passes during use of the showerhead, and
(3) a body fluidically connecting the first end of the showerhead to the second end of the showerhead;
B) a fluid port defined through the body of the showerhead, the fluid port being in operational fluid communication with water passing through the body of the showerhead so that water flowing through the body of the showerhead flows into and out of the fluid port;
C) a soap container unit adapted to mount on the body of the showerhead and including
(1) a fluid flow port which is fluidically connected to the fluid port to be in fluid communication with water flowing through the body of the shower head so that water flowing through the body of the showerhead flows into and out of the fluid flow port via the fluid port, the fluid flow port of the soap container unit including an inlet section and an outlet section with a one-way valve on the inlet section and a one-way valve on the outlet section so fluid flows into the soap container via the fluid flow port and via the fluid port from the body of the showerhead via the inlet section and out of the fluid port via the fluid flow port back into the body of the showerhead via the outlet section, and
(2) a connection element on the soap container which connects the soap container to the body of the showerhead with the fluid flow unit in fluid communication with the fluid port of the showerhead; and
D) soap contained in the soap container.

2. The showerhead system defined in claim 1 wherein the soap container is triangular in shape.

3. The showerhead system defined in claim 2 wherein the soap is triangular in shape.

4. A showerhead system comprising:
A) a showerhead which includes
(1) a first end that is a water inlet end and which is fluidically connected to a source of water,
(2) a second end which is a showerface and which has a multiplicity of water outlet ports defined therethrough through which water from the inlet end passes during use of the showerhead, and
(3) a body fluidically connecting the first end of the showerhead to the second end of the showerhead;
B) a fluid port defined through the body of the showerhead, the fluid port being in operational fluid communication with water passing through the body of the showerhead so that water flowing through the body of the showerhead flows into and out of the fluid port; and
C) a soap container unit adapted to mount on the body of the showerhead and including
(1) a fluid flow port which is fluidically connected to the fluid port to be in fluid communication with water flowing through the body of the shower head so that water flowing through the body of the showerhead creates lower air pressure than the air pressure within the soap container unit to draw liquid soap within the soap container unit into the body of the showerhead to mix the liquid soap with the water flowing through the body,
(2) an air inlet port to substantially maintain an atmospheric pressure within the soap container unit, and
(3) a connection element on the soap container which connects the soap container to the body of the showerhead with the fluid flow unit in fluid communication with the fluid port of the showerhead.

5. The showerhead unit system of claim 4 including a plurality of replaceable soap container units.
